(19) United States
(12) Patent Application Publication
(10) Pub. No.: US 2024/0126140 A1
(43) Pub. Date: Apr. 18, 2024

(54) MECHANICAL SUNSHADE

(71) Applicant: Raytheon Company, Waltham, MA (US)

(72) Inventors: Brook Garrettson, Renton, WA (US); Lacy G. Cook, El Segundo, CA (US); Andrew L. Bullard, Manhattan Beach, CA (US)

(73) Assignee: Raytheon Company, Waltham, MA (US)

(21) Appl. No.: 18/486,394

(22) Filed: Oct. 13, 2023

Related U.S. Application Data
(60) Provisional application No. 63/379,471, filed on Oct. 14, 2022.

(51) Int. Cl. G03B 11/04

(52) U.S. Cl. CPC G03B 11/043

(57) ABSTRACT

A movable sunshade system includes a baffle extending along a central axis of an entrance pupil of a lens and a sunshade movably connected to the baffle. The sunshade includes a first portion shaped to cover a portion of the baffle that is spaced from the first end of the baffle and a second portion that extends from the first portion. The second portion is shaped to cover a portion of a field of view (FOV) of the entrance pupil. The movable sunshade system further includes an actuator configured to move at least one of the baffle or the sunshade to selectively cover portions of the FOV of the entrance pupil.

### FIELD OF DISCLOSURE

This application claims priority to U.S. Provisional Patent Application No. 63/379,471, filed on Oct. 14, 2022, and titled “MECHANICAL SUNSHADE,” the entirety of which is incorporated herein by reference.

### FIELD OF DISCLOSURE

The disclosure relates to movable mechanical sunshade systems.

### DESCRIPTION OF RELATED ART

Various applications involve capturing images by way of a lens structure in movable vehicle, such as a satellite or flying aerial vehicle. During transit of the vehicle, it is desirable to cover the lens structure to prevent debris and like from negatively impacting the lens structure. Conventionally, a pivotable sunshade is used that can block the lens structure during transit and can be pivoted out of the way during image capture.

### SUMMARY

During image capture, undesired light may negatively impact the image, and a field of view (FOV) of the lens structure can be occluded to block out the light and capture a better image. However, using a conventional sunshade to selectively occlude portions of the FOV of the lens structure is imprecise because conventionally an entrance pupil of lens structure is smaller than an end of the lens structure covered by the sunshade. Because the cross-sectional area of the conventional sunshade is larger than the cross-sectional area of the entrance pupil, moving the conventional sunshade to selectively occlude portions of the FOV results in unintended ancillary portions being occluded as well due to the size difference between the conventional sunshade and the entrance pupil.

A movable sunshade system includes a sunshade with a first portion shaped to cover an end of a baffle of a lens structure and a second portion that extends from the first portion and shaped to cover a portion of an entrance pupil. The movable sunshade system can include an actuator to rotate the baffle and/or the sunshade to selectively cover portions of an FOV of the entrance pupil.

According to an aspect of the disclosure, a movable sunshade system comprising: a baffle extending along a central axis of an entrance pupil of a lens, wherein the baffle includes a first end shaped to extend around the entrance pupil; a sunshade movably connected to the baffle, wherein the sunshade comprises a first portion shaped to cover a portion of the baffle that is spaced from the first end of the baffle, wherein the sunshade includes a second portion that extends from the first portion; and an actuator configured to move at least one of the baffle or the sunshade to selectively cover portions of the FOV of the entrance pupil.

According to an embodiment of any paragraph(s) of this summary, the first portion has a larger cross-sectional area than a cross-sectional area of the second portion.

According to an embodiment of any paragraph(s) of this summary, the first portion has a first circular cross-section, wherein the second portion has a second circular cross-section, wherein the first portion and the second portion arranged such that a center of the second circular cross-section aligns with an edge of the first circular cross-section.

According to an embodiment of any paragraph(s) of this summary, the actuator is configured to rotate the sunshade about a rotational axis, wherein the rotational axis is parallel with the central axis.

According to an embodiment of any paragraph(s) of this summary, the first portion has a circular cross-section, wherein a pivot point of the sunshade about the rotational axis is on an edge of the circular cross-section.

According to an embodiment of any paragraph(s) of this summary, further including a second actuator configured to rotate the baffle about the central axis, wherein the sunshade is attached to the baffle such that rotation of the baffle also moves the sunshade about the central axis.

According to an embodiment of any paragraph(s) of this summary, a cross-sectional area of the second portion is based on a predetermined threshold exclusion zone of the entrance pupil.

According to an embodiment of any paragraph(s) of this summary, the first portion is shaped to cover a second end of the baffle that is opposite the first end.

According to an embodiment of any paragraph(s) of this summary, the actuator is configured to linearly move the sunshade along a linear axis, wherein the linear axis is perpendicular to the central axis.

According to an embodiment of any paragraph(s) of this summary, the baffle has a conical shape where the first end has a first cross-section, wherein the baffle has a second end opposite the first end having a second cross-section that is larger than the first cross-section.

According to an embodiment of any paragraph(s) of this summary, the first portion has a first rectangular cross-section, wherein the second portion has a second rectangular cross-section.

According to another aspect of the disclosure, a movable sunshade system comprising: a baffle extending along a central axis of an entrance pupil of a lens, wherein the baffle includes a first end shaped to extend around the entrance pupil; a sunshade movably mounted at a second end of the baffle that is opposite the first end, wherein the sunshade includes a first portion shaped to cover an aperture formed at the second end forms, wherein the sunshade further includes a second portion shaped to cover a portion of an FOV of the entrance pupil; a first actuator configured to move the sunshade relative to the baffle to selectively cover the FOV of the entrance pupil; and a second actuator configured to rotate the baffle about the central axis, wherein rotation of the baffle causes a corresponding rotation of the sunshade around the central axis.

According to an embodiment of any paragraph(s) of this summary, the first actuator is configured to rotate the sunshade about a rotational axis, wherein the rotational axis is parallel to the central axis.

According to an embodiment of any paragraph(s) of this summary, a pivot point of the sunshade about the rotational axis is formed on an edge of the first portion.

According to an embodiment of any paragraph(s) of this summary, the first actuator is configured to move the sunshade along a linear axis, wherein the linear axis is perpendicular to the rotational axis.

According to an embodiment of any paragraph(s) of this summary, the first end has a first cross-sectional area, wherein the second end has a second cross-sectional area that is larger than the first cross-sectional area.

According to an embodiment of any paragraph(s) of this summary, the first portion has a first cross-sectional area, wherein the second portion has a second cross-sectional area that is smaller than the first cross-sectional area.

According to yet another aspect of the disclosure, a method of operating a movable sunshade system comprising: rotating a sunshade about a rotational axis to selectively cover portions of an entrance pupil of a lens, wherein the sunshade is rotationally attached to a baffle that extends along a central axis of the entrance pupil, wherein the sunshade is attached to a second end of the baffle that is opposite a first end shaped to surround the entrance pupil, wherein the sunshade includes a portion with a cross-section shaped to cover a predetermined threshold occlusion zone of the entrance pupil; and selectively rotating the baffle to rotate the sunshade about the central axis.

According to an embodiment of any paragraph(s) of this summary, further comprising rotating the sunshade about the rotational axis to cover an aperture formed by the second end, wherein the sunshade includes a second portion with a cross-section configured to completely cover the aperture

According to an embodiment of any paragraph(s) of this summary, the rotational axis of the sunshade is parallel to the central axis of the entrance pupil.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description when considered in conjunction with the drawings.

### BRIEF DESCRIPTION OF DRAWINGS

The annexed drawings, which are not necessarily to scale, show various aspects of the disclosure.

FIG. 1 is a view of a movable sunshade system according to an embodiment of the disclosure.

FIG. 2 is a view of a sunshade according to an embodiment of the disclosure.

FIG. 3 is a view of the sunshade of FIG. 2 movably attached to a baffle according to an embodiment of the disclosure.

FIG. 4 is a view of another sunshade movably attached to a baffle in a first position according to an embodiment of the disclosure.

FIG. 5 is a view sunshade of FIG. 4 in a second position.

FIG. 6 illustrates different images captured by different movable sunshade systems according to further embodiments of the disclosure.

FIG. 7 is a view of a sunshade according to another embodiment of the disclosure.

FIG. 8 is a view of the sunshade of FIG. 7 movably attached to a baffle according to another embodiment of the disclosure.

### DETAILED DESCRIPTION

Aspects of the present application pertain to a movable sunshade system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Disclosed is a movable sunshade system includes a sunshade with a first portion shaped to cover an end of a baffle of a lens structure and a second portion that extends from the first portion and shaped to cover a portion of an entrance pupil. The movable sunshade system can include a movement mechanism (e.g., an actuator) configured to rotate the baffle and/or the sunshade to selectively cover portions of an FOV of the entrance pupil. In a number of embodiments described herein, the movement mechanism comprises an actuator, however any different mechanism capable of moving the sunshade and/or the baffle is considered.

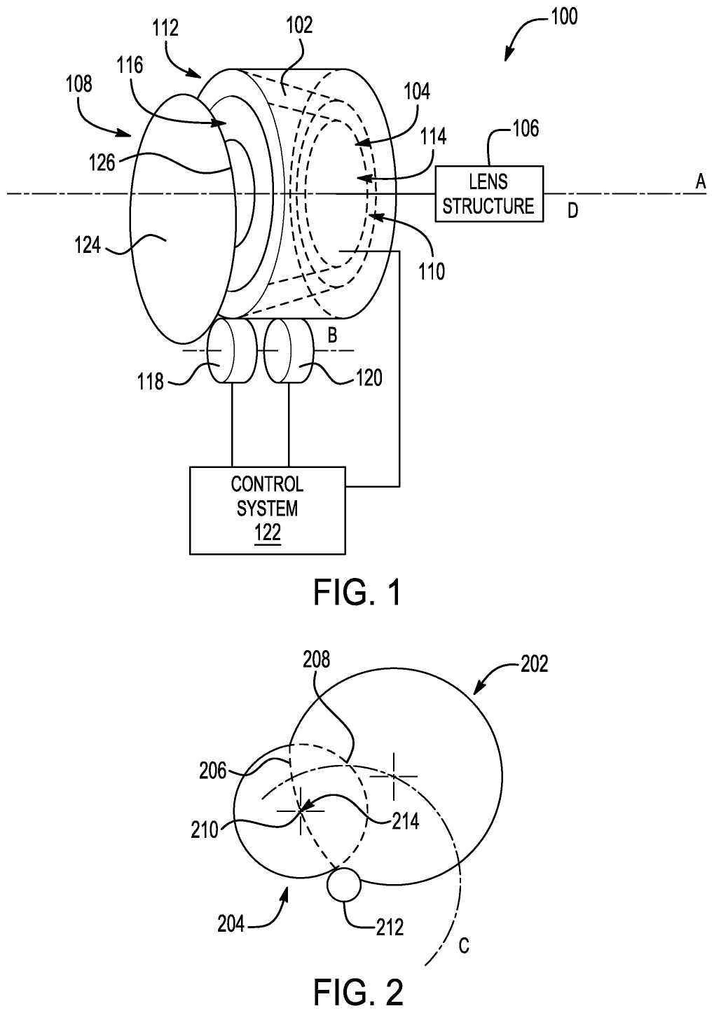

Turning now to FIG. 1, a movable sunshade system 100 is illustrated that includes a baffle 102 attached to an entrance pupil 104 of a lens structure 106 (illustrated in dotted line in FIG. 1), a sunshade 108 connected to the baffle 102, and one or more actuators (e.g., the first actuator 118 and the second actuator 120) configured to move at least one of the baffle 102 or the sunshade 108 to selectively cover portions of field of view (FOV) of the entrance pupil 104. The actuator(s) can be used to selectively cover different portions of the FOV of the entrance pupil 104 to allow for scene capture via the lens structure 106 even when an undesirable object is in the FOV. In an exemplary embodiment, the movable sunshade system 100 can be used to exclude solar interference in the FOV.

The movable sunshade system 100 can be applied to any suitable lens structure 106, such as a lens structure of a satellite, a lens structure of a telescope, a lens structure of an aerial vehicle, and/or the like. For example, the movable sunshade system 100 can be employed on the lens structure of a satellite to selectively occlude interference by occluding a portion of an FOV of the satellite. In another example, the movable sunshade system 100 can be employed in the lens structure of an aerial vehicle to selectively occlude portions of an FOV to steer the aerial vehicle.

The baffle 102 can be used to limit an amount of external light that reaches the entrance pupil 104 of the lens structure 106. The baffle 102 can take any suitable shape, size, and/or configuration for this purpose and may be based on the amount of light to be kept out, the shape of the lens structure 106, the shape of the entrance pupil, the shape of the sunshade 108, and/or the like. In the illustrated embodiment, the baffle 102 extends linearly along a central axis A, however different configurations are imaginable such as angled portions, curved portions, or the like. The illustrated baffle 102 is symmetrical about the central axis A but opposing sides can have different shapes, such as a first side can be curved while an opposing second side can be planar.

The illustrated baffle 102 is a conical baffle 102 with a first end 110 having a first cross-section, and a second end 112 having a second cross-section that is larger than the first cross-section. In another embodiment, the baffle 102 can have a uniform cross-section along a length of the baffle 102.

The baffle 102 can further include a first aperture 114 at the first end 110 such that the first end 110 can extend around a portion of the entrance pupil 104. In the illustrated embodiment, the first aperture 114 is shaped such that the first end 110 extends around the entire entrance pupil 104. In another embodiment, the first aperture 114 is shaped such that the first end 110 extends around a portion of the entrance pupil 104 that is less than the entire entrance pupil 104.

The baffle 102 can further include a second aperture 116 at the second end 112 to allow light into the baffle 102 for image capture with the entrance pupil 104. The first aperture 114 and the second aperture 116 can have similar cross-sections or can vary. In the illustrated embodiment, similar to the body of the baffle 102, the first aperture 114 has a first cross-sectional area and the second aperture 116 has a second cross-sectional area that is larger than the first cross-sectional area.

Moreover, the cross-section of at the first end 110 and the cross-section of the first aperture 114 may have a similar shape and/or can vary. For instance, the first end 110 may have one cross-section (e.g., rectangular) while the first aperture 114 may have a different cross-section (e.g., circular). The same can be applied for the second end 112 and the second aperture 116. In the illustrated embodiment, the cross-section of the first end 110, the second end 112, the first aperture 114, and the second aperture 116 all have a similar circular shape.

The baffle 102 can be placed at any suitable location relative to the entrance pupil 104 and in the illustrated embodiment, the central axis A of the baffle 102 is aligned with a central axis D of the entrance pupil 104. In another embodiment, the central axis A of the baffle 102 can be offset from the central axis of the entrance pupil 104.

As noted above, the sunshade 108 is attached to the baffle 102 and can be selectively moved to cover different portions of field of view the entrance pupil 104, to protect the lens structure 104 and/or exclude certain portions of a view of the entrance pupil 104. The sunshade 108 can be attached to any suitable portion of the baffle 102, such as an end of the baffle 102 or a portion along a length of the baffle 102. In the illustrated embodiment, the baffle 102 includes a first end 110 attached adjacent the entrance pupil 104 and a second end 112 that is opposite the first end 110 and the sunshade 108 is attached to the second end 112.

The actuator(s) is configured to move the sunshade 108 to cover different portions of the FOV of the entrance pupil 104. In a first embodiment, an actuator rotates the baffle 102 about the central axis A of the baffle 102 and because the sunshade 108 is connected to the baffle 102, the sunshade 108 similarly rotates about the central axis A to cover different portions of the FOV. In another embodiment, an actuator rotates the sunshade 108 about a pivot axis to selectively cover different portions of the FOV. In yet another embodiment, the actuator moves the sunshade linearly with respect to the entrance pupil along an axis at an angle (e.g., perpendicular) with respect to the central axis A.

Moreover, the movable sunshade system 100 may include any suitable number of actuators (e.g., first actuator 118 and/or second actuator 120). The actuators may have similar components and arrangements and/or can vary. For instance, the first actuator 118 can be configured to rotate a portion of the movable sunshade system 100 and the second actuator 120 can be configured to linearly move a second portion of the movable sunshade system 100. In another example, the first actuator 118 is a first rotation actuator type and the second actuator 120 is a second rotation actuator type that is different from the first rotation actuator type. Any suitable actuators configured to complete the movements described below can be used and different types may be used for different movements. For instance, actuators may be linear actuators, rotary motor actuators, thermal actuators, magnetic actuators, electric motor actuators, mechanical actuators, pneumatic actuators, hydraulic actuators, motorized actuators, and/or the like.

In the illustrated embodiment, the movable sunshade system 100 includes a first actuator 118 and a second actuator 120 illustrated as schematic figures. The first actuator 118 can be configured to rotate the baffle 102, and by extension the sunshade 108, about the central axis A. The second actuator 120 can be configured to rotate the sunshade 108 about a rotational axis B. The central axis A and the rotational axis B can have any suitable arrangement. In the illustrated embodiment, the central axis A and the rotation axis B are spaced apart and parallel.

The movable sunshade system 100 may further include a control system 122 configured to control one or more components of the movable sunshade system 100, illustrated schematically in FIG. 1. The control system 122 can be connected to the first actuator 118, the second actuator 120, the lens structure 108, a sensor(s), and/or the like. The control system 122 can be configured to move the sunshade 108, baffle 102, and/or the like based on a received input. For instance, after detecting that a portion of the FOV of the entrance pupil 104 should be occluded (e.g., detecting undesired light in the FOV), the control system 122 can drive the first actuator 118 and/or the second actuator 120 to occlude the portion of the FOV. In another example, the control system 122 may drive the first actuator 118 and/or the second actuator 120 to block the second end 112 of the baffle 102 during transit.

As can be partially seen in FIG. 1, and better illustrated in the figures discussed below, the sunshade 108 can include different portions with different sizes, shapes, and/or configurations. For instance, in the embodiment illustrated in FIG. 1, the sunshade 108 includes a first portion 124 with a first cross-section and a second portion 126 with a different cross-section. As will be described in detail below, the different portions 124 and 126 of the sunshade 108 can be used to cover different maximum portions of the FOV of the entrance pupil 104.

Turning now to FIG. 2, illustrated is an exemplary sunshade 200 in isolation. The sunshade 200 may include any suitable number of portions, and in the illustrated embodiment, the sunshade 200 has a first portion 202 and a second portion 204. The first portion 202 and/or the second portion 204 can take any suitable shape and/or size and may be similar or can vary. As mentioned above, during transit it may be desirable to cover an end of a baffle to prevent debris from the entering the baffle and disrupting a FOV of an entrance pupil. Accordingly, the conventional sunshade may be shaped to cover the entire end of the baffle (or at least the aperture at the end of the baffle). However, using the conventional sunshade to selectively occlude portions of the FOV of the entrance pupil during image capture, such as to occlude undesired light from the sun, is imprecise when the end covered during transit has a larger cross-sectional area than the cross-sectional area of the entrance pupil. More particularly, because the cross-sectional area of the conventional sunshade is larger than the cross-sectional area of the entrance pupil, moving the conventional sunshade to selectively occlude portions of the FOV results in unintended ancillary portions being occluded as well due to the size difference between the conventional sunshade and the entrance pupil. To overcome these shortcomings, the sunshades described herein include different portions with different cross-sections, namely a first portion for covering the end of the baffle and a second portion for selectively occluding a portion of the FOV of the entrance pupil.

In the embodiment illustrated in FIG. 2, the first portion 202 of the sunshade 200 has a cross-section shaped to cover at least the aperture at the end of a baffle, and in some embodiments may cover the entire end of the baffle. The second portion 204 is configured to protrude from the first portion 202 with a cross-sectional area that is smaller than the cross-sectional area of the first portion 202. By using a smaller cross-section second portion 204 that extends from the first portion 202, the illustrated sunshade 200 can be both used to cover the end of the baffle entirely during transit and selectively covering portions of the FOV of the entrance pupil with a smaller cross-section and thus less unintended ancillary portions being occluded.

The second portion 204 can have any suitable cross-section and may depend on the first portion 202, the baffle, the entrance pupil, and/or the like. For instance, the cross-section of the second portion 204 may depend on a predetermined threshold exclusion zone of an entrance pupil. More particularly, the entrance pupil may include a predetermined threshold amount of the FOV that can be occluded before a captured image is unusable and/or no image can be captured.

The shape of the cross-section of the first portion 202 and the cross-section of the second portion 204 may be similar and/or can vary. For instance, the cross-section of the first portion 202 can be a first shape (e.g., rectangular), while the cross-section of the second portion 204 can be a second shape (e.g., circular). In the illustrated embodiment, both the cross-section of the first portion 202 and the cross-section of the second portion 204 are circular.

The first portion 202 and the second portion 204 can have any suitable arrangement with respect to one another. In one embodiment, the first portion 202 and the second portion 204 can be attached at their respective edges, e.g., the first portion 202 and the second portion 204 can be complete cross-sectional circle shapes that are then connected at a point on their edge. In another embodiment, the sunshade 200 constitutes merged shapes, more particularly, the cross-sectional shape of the first portion 202 and the cross-sectional shape of the second portion 204 may be at least partially merged. Any suitable amount of merging is envisioned and may depend on cross-sectional size of the first portion 202, cross-sectional size of the second portion 204, size of the entrance pupil, capabilities of the lens structure 106, and/or the like.

In the illustrated embodiment, the cross-sectional circular shape of the second portion 204 merges with the cross-sectional circular shape of the first portion 202. The illustrated sunshade 200 includes a first dashed-line example 206 corresponding to the first portion 202 and a second dashed-line example 208 corresponding to the second portion 204 to indicate how the circular cross-sections merge. As stated above, any suitable overlap is possible and in the illustrated embodiment the second portion 204 and the first portion 202 are arranged such that a center 210 of the circular cross-section of second portion 204 is on an edge 214 of the circular cross-section of the first portion 202.

An actuator for moving the sunshade 200 can be connected to sunshade 200 at any suitable location for moving the sunshade 200 to block an end of a baffle opposite an end of the baffle that surrounds an entrance pupil (e.g., the second end 112) via the first portion 202 and to occlude portions of the FOV via the second portion 204. In the illustrated embodiment, an actuator (e.g., the first actuator 118) is configured to rotate the sunshade about pivot point 212 is shown at an edge of the first portion 202 adjacent the merged portions of the first portion 202 and the second portion 204. The actuator is configured to rotate the sunshade 200 along travel path C.

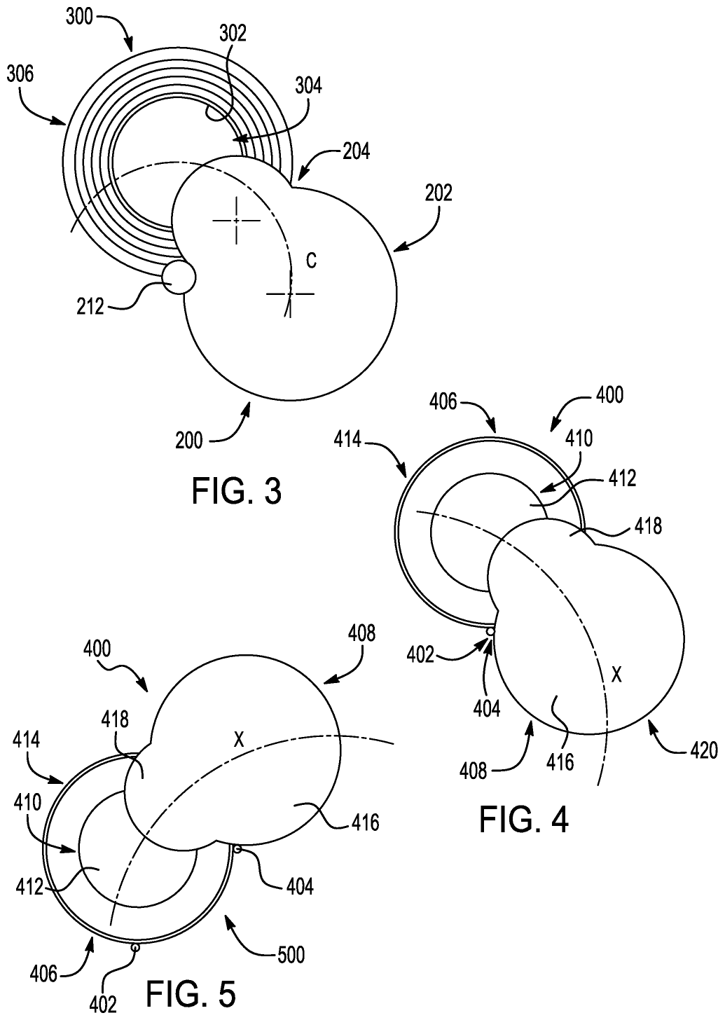

As noted above, an actuator can be configured to move a sunshade to selectively occlude portions of an FOV of an entrance pupil and to move the sunshade to cover an end of a baffle. Turning now to FIG. 3, illustrated is an exemplary embodiment where the actuator is configured to rotate the sunshade about pivot point 212 is configured to rotate the sunshade 200 with respect to a baffle 300. The illustrated baffle 300 is a conical with a first aperture 302 at a first end shaped for an entrance pupil 304 and a second aperture 306 at a second end to allow light into the baffle 300. The first portion 202 of the sunshade 200 is shaped to cover the second end, and by extension the second aperture 306. In comparison, the second portion 204 has a smaller cross-sectional area compared to the first portion 202, as described above, and is shaped to selectively occlude portions of the FOV of the entrance pupil 304.

As further noted above, a sunshade can be attached to a baffle and an actuator can be configured to rotate the baffle and, by extension, the attached sunshade. By rotating the buffer and attached sunshade, the actuator can account for different positions of a lens structure with respect to light to be occluded by the sunshade. The movable sunshade system 100 can include a baffle rotation actuator and/or a sunshade rotation actuator.

Illustrated in FIGS. 4 and 5 are embodiments of a movable sunshade system 400 that includes a first actuator conceptually illustrated at 402 configured to rotate a baffle 406 and a second actuator conceptually illustrated at 404 configured to rotate a sunshade 408 along travel path X. Like the above-described baffles, the baffle 406 is conical with a first aperture 410 at a first end shaped for an entrance pupil 412 and a second aperture 414 at a second end that is larger than the first aperture 410 and configured to allow light into the baffle 406 for image capture by the entrance pupil 412. The illustrated sunshade 408 includes a first portion 416 shaped to cover the second aperture 414 at the second end and a second portion 418 extending from the first portion 416 shaped to occlude portions of the FOV of the entrance pupil 412.

In an initial position 420 in FIG. 4, the first actuator 402 and the second actuator 404 are aligned at the bottom. In the initial position, the travel path X of the sunshade 408 extends from a lower left portion to an upper right portion of the FOV of the entrance pupil 412. Accordingly, the second portion 418 to occlude undesired light in that path.

However, when the undesired light is located somewhere other than along the travel path X in FIG. 4, the second actuator 404 and/or the sunshade 408 has to be repositioned such that the travel path X now extends through the undesired light. In one example, the entire lens structure can be moved to reposition the sunshade 408; however, rotating the entire lens structure may be difficult and cumbersome, such as when the lens structure is part of a satellite or other aerial vehicle. Accordingly, the illustrated movable sunshade system 400 includes the first actuator 402 that is configured to rotate the baffle 406. The second actuator 404 can be connected to the baffle 406 such that rotation of the baffle 406 rotates the second actuator 404 and, by extension, the sunshade 408 attached to the second actuator 404.

Illustrated in FIG. 5 is the movable sunshade system 400 in position 500 where the first actuator 402 has rotated the baffle 406 to change the position of travel path X with respect to the FOV of the entrance pupil 412. In position 500, the baffle 406 has been rotated 90 degrees and the travel path X now extends from an upper left portion to a lower right portion of the FOV of the entrance pupil 412. Thus, by rotating the baffle 406, the movable sunshade system 400 can account for any different position of the light to be occluded.

As noted above, the size of the second portion configured to occlude portions of the FOV that protrudes from the first portion can vary in size and shape. As can be seen by comparing the sunshade 408 in FIG. 4 and the sunshade 200 in FIG. 2, the second portion 418 of sunshade 408 is smaller than the second portion 204 of sunshade 200. The second portion may be smaller when the maximum amount of the FOV that can be occluded while also being able to capture an appropriate image is smaller for a first lens structure compared to a second lens structure.

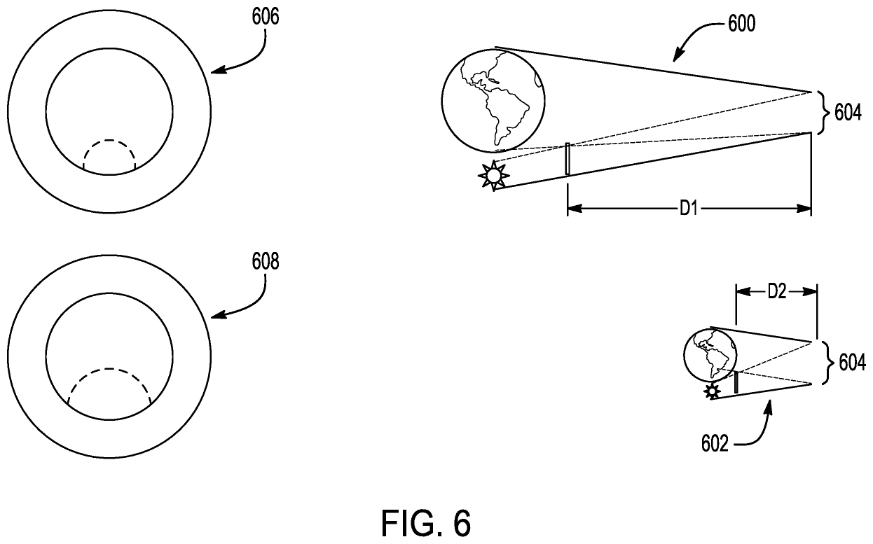

Moreover, as noted above, the size of the second portion of a sunshade used to occlude the FOV of an entrance pupil may depend on the size of the baffle. For instance, the size of the second portion may depend on a length of the baffle. Illustrated in FIG. 6 is a comparison of different length baffles and how the length impacts the occlusion amount for similar size sunshades. In yet another embodiment 600, a sunshade is offset distance D1 from the entrance pupil 604 by way of a first baffle; while in a second embodiment 602, a sunshade is offset distance D2 from the entrance pupil 604 by way of a second baffle and D2 is smaller than D1. When the same undesired light is present at the second end of the respective baffles, the shorter distance D2 results in more occlusion of the FOV when the sunshade is moved to occlude the light. This can be seen when comparing image 606 which represents an image captured by the first embodiment 600 to image 608 which represents an image captured by the second embodiment 602. In image 606, a first portion of the image is obscured because the sunshade occludes the FOV of the entrance pupil 604. In contrast, in image 608, a second portion of the image is obscured that is larger than the first portion because the sunshade occludes more of the FOV of the entrance pupil 604 to block the light.

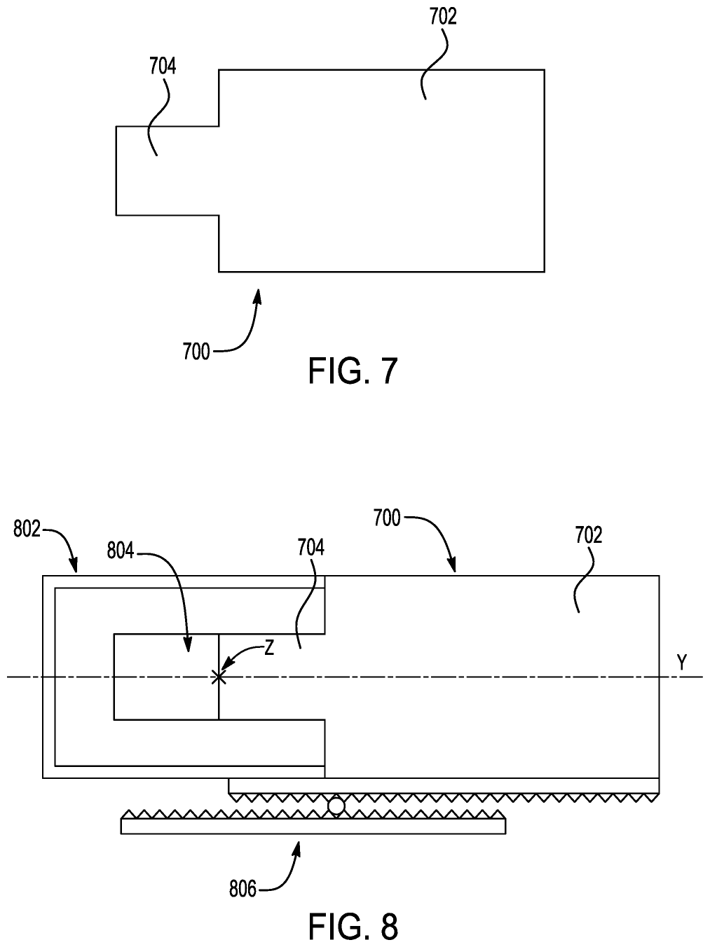

As mentioned above, the sunshade can take any suitable shape and different portions may have different shapes based on the entrance pupil, the baffle, and/or the like. Illustrated in FIG. 7 is a sunshade 700 that includes one or more rectangular portions, in contrast to the circular portions of sunshade 200 (FIG. 2). More particularly, the illustrated sunshade 700 includes a first portion 702 that has a first rectangular cross-section and a second portion 704 that extends from the first portion 702 and has a second rectangular cross-section that is smaller than the first rectangular cross-section. In one embodiment, the sunshade 700 can be used with the actuators described above, e.g., the sunshade 700 can be rotated about a rotational axis. In another embodiment, due to the shape of the second portion 704, an actuator can be configured to move the sunshade 700 along a linear axis.

Illustrated in FIG. 8 is a movable sunshade system 800 employing the sunshade 700 that is moved linearly along a movement axis Y with respect to a baffle 802 and an entrance pupil 804. The movement axis Y can have any suitable orientation with respect to a central axis Z of the entrance 804 and in the illustrated embodiment, the movement axis Y is perpendicular to the central axis. A linear movement mechanism, such as linear rotary mechanism 806 can be used to move the sunshade 700 along the movement axis Y. The movable sunshade system 800 may further include a second actuator configured to rotate the baffle 802, similar to the actuator described above.

Although the disclosure shows and describes certain preferred embodiment or embodiments, it is obvious that equivalent alterations and modifications will occur to others skilled in the art upon the reading and understanding of this specification and the annexed drawings. In particular regard to the various functions performed by the above described elements (external components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A movable sunshade system comprising:
a baffle extending along a central axis of an entrance pupil of a lens, wherein the baffle includes a first end shaped to extend around the entrance pupil;
a sunshade movably connected to the baffle, wherein the sunshade comprises a first portion shaped to cover a portion of the baffle that is spaced from the first end of the baffle, wherein the sunshade includes a second portion that extends from the first portion; and
an actuator configured to move at least one of the baffle or the sunshade to selectively cover portions of the FOV of the entrance pupil.

2. The movable sunshade system of claim 1, wherein the first portion has a larger cross-sectional area than a cross-sectional area of the second portion.

3. The movable sunshade system of claim 1, wherein the first portion has a first circular cross-section, and the second portion has a second circular cross-section, the first portion and the second portion being arranged such that a center of the second circular cross-section aligns with an edge of the first circular cross-section.

4. The movable sunshade system of claim 1, wherein the actuator is configured to rotate the sunshade about a rotational axis, wherein the rotational axis is parallel with the central axis.

5. The movable sunshade system of claim 4, wherein the first portion has a circular cross-section, wherein a pivot point of the sunshade about the rotational axis is on an edge of the circular cross-section.

6. The movable sunshade system of claim 5, further including a second actuator configured to rotate the baffle about the central axis, wherein the sunshade is attached to the baffle such that rotation of the baffle also moves the sunshade about the central axis.

7. The movable sunshade system of claim 1, wherein a cross-sectional area of the second portion is based on a predetermined threshold exclusion zone of the entrance pupil.

8. The movable sunshade system of claim 1, wherein the first portion is shaped to cover a second end of the baffle that is opposite the first end.

9. The movable sunshade system of claim 1, wherein the actuator is configured to linearly move the sunshade along a linear axis, wherein the linear axis is perpendicular to the central axis.

10. The movable sunshade system of claim 1, wherein the baffle has a conical shape where the first end has a first cross-sectional area, wherein the baffle has a second end opposite the first end having a second cross-sectional area that is larger than the first cross-sectional area.

11. The movable sunshade system of claim 1, wherein the first portion has a first rectangular cross-section, wherein the second portion has a second rectangular cross-section.

12. A movable sunshade system comprising:
a baffle extending along a central axis of an entrance pupil of a lens, wherein the baffle includes a first end shaped to extend around the entrance pupil;
a sunshade movably mounted at a second end of the baffle that is opposite the first end, wherein the sunshade includes a first portion shaped to cover an aperture formed at the second end forms, wherein the sunshade further includes a second portion shaped to cover a portion of an FOV of the entrance pupil;
a first actuator configured to move the sunshade relative to the baffle to selectively cover the FOV of the entrance pupil; and
a second actuator configured to rotate the baffle about the central axis, wherein rotation of the baffle causes a corresponding rotation of the sunshade around the central axis.

13. The movable sunshade system of claim 12, wherein the first actuator is configured to rotate the sunshade about a rotational axis, wherein the rotational axis is parallel to the central axis.

14. The movable sunshade system of claim 13, wherein a pivot point of the sunshade about the rotational axis is formed on an edge of the first portion.

15. The movable sunshade system of claim 12, wherein the first actuator is configured to move the sunshade along a linear axis, wherein the linear axis is perpendicular to the rotational axis.

16. The movable sunshade system of claim 12, wherein the first end has a first cross-sectional area, wherein the second end has a second cross-sectional area that is larger than the first cross-sectional area.

17. The movable sunshade system of claim 12, wherein the first portion has a first cross-sectional area, wherein the second portion has a second cross-sectional area that is smaller than the first cross-sectional area.

18. A method of operating a movable sunshade system comprising:
rotating a sunshade about a rotational axis to selectively cover portions of an entrance pupil of a lens, wherein the sunshade is rotationally attached to a baffle that extends along a central axis of the entrance pupil, wherein the sunshade is attached to a second end of the baffle that is opposite a first end shaped to surround the entrance pupil, wherein the sunshade includes a portion with a cross-section shaped to cover a predetermined threshold occlusion zone of the entrance pupil; and
selectively rotating the baffle to rotate the sunshade about the central axis.

19. The method of claim 18, further comprising rotating the sunshade about the rotational axis to cover an aperture formed by the second end, wherein the sunshade includes a second portion with a cross-section configured to completely cover the aperture.

20. The method of claim 18, wherein the rotational axis of the sunshade is parallel to the central axis of the entrance pupil.
